(19) United States
(12) Patent Application Publication
(10) Pub. No.: US 2012/0036422 A1
(43) Pub. Date: Feb. 9, 2012

(54) SYSTEM AND METHOD FOR RENDERING FORMS BASED ON AN IDENTIFICATION NUMBER

(75) Inventors: Mathew J. Walczyk, Penfield, NY (US); Jason Tsongas, Rochester, NY (US); Matthew Scrafford, Fairport, NY (US)

(73) Assignee: Xerox Corporation

(21) Appl. No.: 12/849,164

(22) Filed: Aug. 3, 2010

(51) Int. Cl. G06F 17/24

(52) U.S. Cl. 715/226

(57) ABSTRACT

A system and method for rendering a form based on an identification number. A client device including an extensible interface platform (EIP) application can be configured in association with a centralized server via a network. A form category can be selected and the identification number with respect to a form can be entered on a user interface associated with the client device. The form that matches the identification number can be collected from a database associated with the centralized server. The information required for retrieving instruction to populate the form can be entered in the user interface and the form can be rendered based on a user preference. Such an approach reduces the cost of rendering and shipping a large number of forms to a number of locations.

### TECHNICAL FIELD

Embodiments are generally related to multi-function devices such as, for example, printers, scanners, photocopy machines, and the like. Embodiments are additionally related to the rendering of forms and other documents.

### BACKGROUND OF THE INVENTION

Networked rendering devices can interact with an assemblage of other rendering devices, devices, client devices, servers, and other components that are connected to and communicate over a network. One example of a rendering device is an MFD (Multi-Function Device), which includes the functionality of multiple rendering devices such as printers, scanners, faxes, copy machines, and so forth. Each MFD in a network, for example, can include a variety print capabilities options such as, finishing, media quality, supply levels and size.

Such networked rendering devices can be employed for rendering numerous standard documents and business forms in a wide variety of environments. Such documents and forms can be utilized to disseminate, collect and manage information on a number of subjects. For example, a tax form can be rendered in large quantities and provided to a number of locations based on an estimated usage. Such an approach requires planning and maintenance of inventories which is a costly and time consuming activity. Commonly, inventories of forms can run low from time to time, especially when the form usage is unexpectedly high, sometimes resulting in restricting or delaying activities associated with the forms. Additionally, stocking an excessively large number of documents and forms requires more storage space, while also resulting in an excessive number of forms being left over and discarded whenever the documents and forms are changed in design or content.

Based on the foregoing, it is believed that a need exist for an improved form based rendering system and method. A need also exists for an improved method for rendering a form based on an identification number, as described in greater detail herein.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved system for configuring a multifunction device (MFD), such as, a printer, a scanner, a photocopy machine, fax machine, etc, or a combination thereof.

It is another aspect of the disclosed embodiments to provide for an improved form based rendering system and method.

It is further aspect of the disclosed embodiments to provide for an improved method for rendering a form based on an identification number.

The aforementioned aspects and other objectives and advantages can now be achieved as described herein. A system and method for rendering a form based on an identification number, is disclosed herein. A client device (e.g., a multi-function device) including an extensible interface platform (EIP) application can be configured in association with a centralized server via a network. A form category can be selected and the identification number with respect to a form can be entered on a user interface associated with the client device. The form that matches the identification number can be collected from a database associated with the centralized server. The information required for retrieving instruction to populate the form can be entered in the user interface and the form can be rendered based on a user preference. Such an approach reduces the cost of rendering and shipping a large number of forms to a number of locations.

The form category can be selected by the user and can be prompted to enter the identification number associated with the form. An authentication process can be optionally provided to the user before selecting the form in order to pre-populate the form with information associated with the user. Upon authentication the user can be presented with a list of recently used forms and/or commonly used forms in order to pre-populate the form with information associated with the user. The form can be submitted to a rendering device upon selection by the user to render the form. Such an approach updates the forms without rendering and shipping to a delivery point.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an example of a multi-function device coupled to a data-processing apparatus through a network, in accordance with the disclosed embodiments;

FIG. 2 illustrates a block diagram of a form based rendering system, in accordance with the disclosed embodiments;

FIG. 3 illustrates a high level flow chart of operation illustrating logical operation steps of a method for rendering a form based on the identification number, in accordance with the disclosed embodiments;

FIG. 4 illustrates a GUI for entering a form identification number associated with a form, in accordance with the disclosed embodiments; and

FIG. 5 illustrates a GUI that displays the form associated with the form identification number, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

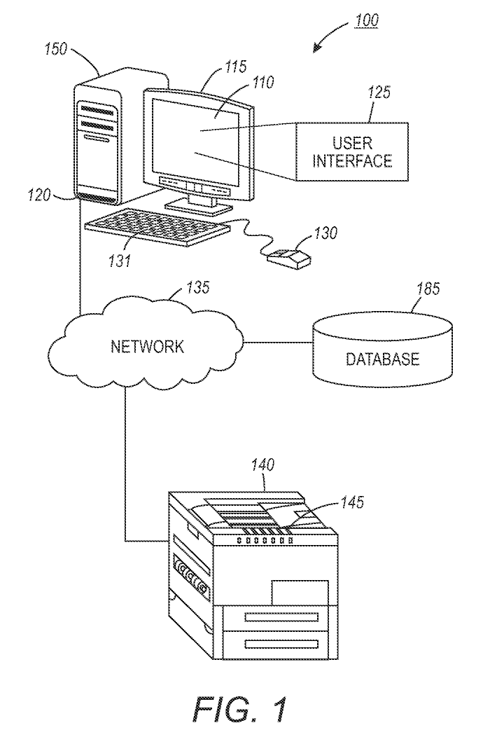

FIG. 1 is provided as an exemplary diagram of data processing environments in which embodiments of the present invention may be implemented. It should be appreciated that FIG. 1 is only exemplary and is not intended to assert or imply any limitation with regard to the environments in which aspects or embodiments of the present invention may be implemented. Many modifications to the depicted environments may be made without departing from the spirit and scope of the present invention.

Referring to FIG. 1, system 100 includes an MFD 140 coupled to a data-processing apparatus 110 through a network 135. The data-processing apparatus 110 may be, for example, a personal computer or other computing device, and generally includes a central processor 120, a display device 115, a keyboard 131, and a pointing device 130 (e.g., mouse, track ball, pen device, or the like). Additional input/output devices, such as the multi-function device 140 may be included in association with the data-processing apparatus 110 as desired.

Note that as utilized herein, the term multi-function device (including the acronym MFD) may refer to an apparatus or system such as a printer, scanner, fax machine, copy machine, etc., and/or a combination thereof. Preferably, MFD 140 is capable of multiple rendering functions such as printing, copying, scanning, faxing, etc. In some embodiments, MFD 140 may be implemented with a single rendering function such as printing. In other embodiments, MFD 140 can be configured to provide multiple rendering functions, such as scanning, faxing, printing and copying.

A non-limiting example of an MFD that can be utilized as MFD 140 is disclosed in U.S. Pat. No. 7,525,676, entitled “System and Method for Controlling Access to Programming Options of a Multi-function device,” which issued on Apr. 28, 2009 to Robert J. Pesar. U.S. Pat. No. 7,525,676, which is incorporated herein by reference in its entirety, is assigned to the Xerox Corporation of Norwalk, Conn. Another non-limiting example of an MFD that can be utilized as MFD 140 is disclosed in U.S. Pat. No. 7,474,428, entitled “Multi-function device System Using Tags Containing Output Information,” which issued on Jan. 6, 2009 to Morris-Jones, et al. U.S. Pat. No. 7,474,428, which is incorporated herein by reference in its entirety, is also assigned to the Xerox Corporation of Norwalk, Conn. An additional example of an MFD that can be utilized as MFD 140 is disclosed in U.S. Pat. No. 5,920,405, entitled “Multi-function device With Printer Facsimile Contention Selection,” which issued on Jul. 6, 1999 to McIntyre, et al. U.S. Pat. No. 5,920,405, which is incorporated herein by reference in its entirety, is also assigned to the Xerox Corporation of Norwalk, Conn.

The data-processing apparatus 110 can be coupled to the MFD 140 through a computer network 135. Network 135 may employ any network topology, transmission medium, or network protocol. Network 135 may include connections, such as wire, wireless communication links, or fiber optic cables. The MFD 140 includes a user interface 145, such as a panel menu. The panel menu may be used to select features and enter other data in the MFD 140. Such interfaces may include, for example, touch screens having touch activated keys for navigating through an option menu or the like.

A MFD driver program can be installed on the data-processing apparatus 110 and can reside on the host device's hard drive 150. The MFD driver program may be activated through an application interface so that a user may generate a print job with the MFD driver for processing by the MFD 140. The data-processing apparatus 110 also includes a GUI 125 for communicating MFD features for processing, for example, a print job to a user and accepting the user's selection of available MFD features. The user interface 125 displays information and receives data through device display and/or the keyboard/mouse combination. The interface 125, also serves to display results, whereupon the user may supply additional inputs or terminate a given session. The data-processing apparatus 110 can be, for example, any computing device capable of being integrated within a network, such as a PDA, personal computer, cellular telephone, point-of-sale terminal, server, etc.

Note that the user interface as utilized herein generally refers to a type of environment that represents programs, files, options and so forth by means of graphically displayed icons, menus, and dialog boxes on a screen. The input device of the multi-function device 140 may be a local user interface 145, such as a touch-screen display or separate keypad and display or a memory fob or the like as discussed above. Alternatively or additionally, the input device may be a wireless port that receives a wireless signal containing constraint data from a portable device. The wireless signal may be an infrared or electromagnetic signal. A system administrator may input constraint data through the local user interface by manipulating the touch screen, keypad, or communicating via wireless messages through the wireless port. The administrator's portable device that communicates wirelessly may be a personal digital assistant (PDA), or the like, as noted above.

The following description is presented with respect to embodiments of the present invention, which can be embodied in the context of a data-processing apparatus 110 and MFD 140 depicted in FIG. 1. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

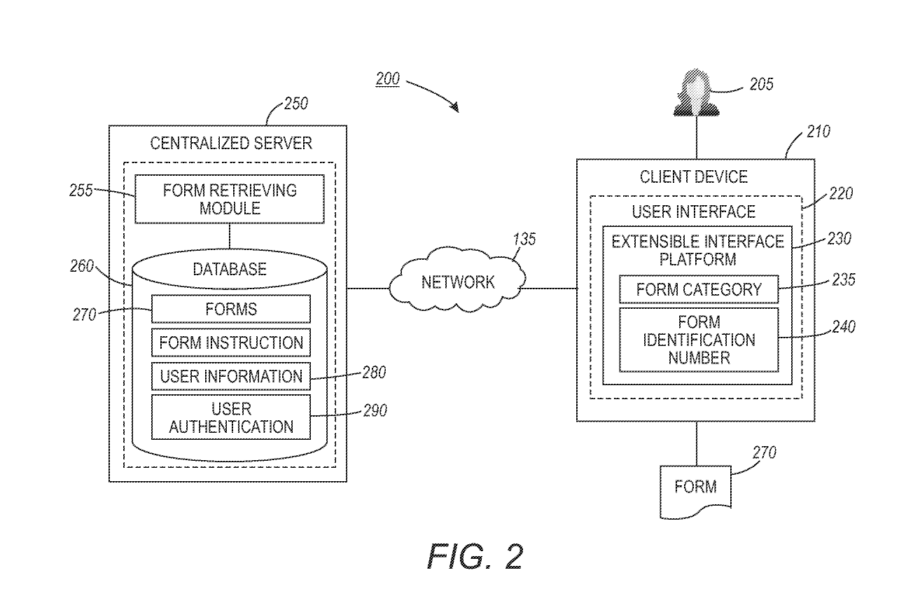

FIG. 2 illustrates a block diagram of a form based rendering system 200, in accordance with the disclosed embodiments. The form based rendering system 200 can be employed in a wide variety of office environments such as, for example, a large corporation, a government agency, and/or other business organizations for rendering the forms 270 with respect to a user 205. The form based rendering system 200 generally includes a client device 210 and a centralized server 250 that are operatively configured in association with the network 135. Data-processing system 110 depicted in FIG. 1 can be, for example, a server.

Network 135 may employ any network topology, transmission medium, or network protocol. The network 135 may include connections, such as wire, wireless communication links, or fiber optic cables. In the depicted example, network 135 is the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages.

The client device 210 includes a user interface 220 that is configured with an EIP (Extensible Interface Platform) application 230 for providing a form category 235 and a form identification number 240 with respect to the user 205. Note that the client device 210 can be a multi-function device 140 that performs rendering operations with respect to the user 205. In some embodiments, multi-function device 140 may be a rendering device such as a printer, scanner, copy machine, etc. The MFD is an office machine which incorporates the functionality of multiple devices in one, so as to provide centralized document management, document distribution and production in a large-office setting and the like. The typical MFD may act as a combination of a printer, scanner, photocopier, fax and e-mail. While the multi-function device 140 is shown by way of example, it is to be appreciated that any number of rendering devices may be linked to the network, such as two, four, six or more multi-function devices. In general, the multi-function device 140 can be employed to perform a rendering output function (e.g., printing, scanning, copying, faxing, etc) within a networked environment.

A form retrieving module 255 associated with the centralized server 250 can be employed to retrieve a form 270 based on a form identification number 240 provided by a user 205. Note that as utilized herein, the term “module” may refer to a physical hardware component and/or to a software module. In the computer programming arts, such a software “module” may be implemented as a collection of routines and data structures that performs particular tasks or implements a particular abstract data type. Modules of this type are generally composed of two parts. First, a software module may list the constants, data types, variable, routines, and so forth that can be accessed by other modules or routines. Second, a software module may be configured as an implementation, which can be private (i.e., accessible only to the module), and which contains the source code that actually implements the routines or subroutines upon which the module is based.

Therefore, when referring to a “module” herein, the inventors are generally referring to such software modules or implementations thereof. The methodology described herein can be implemented as a series of such modules or as a single software module. Such modules can be utilized separately or together to form a program product that can be implemented through signal-bearing media, including transmission media and recordable media. The present invention is capable of being distributed as a program product in a variety of forms, which apply equally regardless of the particular type of signal-bearing media utilized to carry out the distribution.

Examples of signal-bearing media can include, for example, recordable-type media, such as floppy disks, hard disk drives, CD ROMs, CD-Rs, etc., and transmission media, such as digital and/or analog communication links. Examples of transmission media can also include devices such as modems, which permit information to be transmitted over standard telephone lines and/or the more advanced digital communications lines.

The extensible interface platform (EIP) application 230 associated with the client device 210 permits the user 205 to select the form category 235 and to enter the form identification number 240 with respect to the form 270 at the user interface 220 associated with the client device 210. The extensible interface platform application 230 can be a software platform upon which a developer utilizes standard web-based tools to create server-based applications that can be configured for the rendering device user interface 220. The form 270, form instruction 275, user information 280 and user authentication 290 can be stored in a database 260 associated with the centralized server 250.

The centralized server 250 retrieves a list of forms that matches the identification number 240 from the database 260 associated with the centralized server 250. The information required for retrieving instruction 275 to populate the form 270 can be entered in the user interface 220 and the form 270 can be rendered based on a user preference. For example, to retrieve a tax form, a tax form identification number (e.g., 1040) can be entered at the user interface 220 associated with the client device 210. The centralized server 250 retrieves a list of tax forms related to the tax form identification number and the directions to fill the tax form.

The form identification number 240 with respect to the form 270 can be also entered via a card reader and/or other integrated input devices. Optionally, the rendering system 200 includes a user authentication 290 for selecting the forms 270 from the server 250. Upon authentication the user 205 can be presented with a list of recently used forms and/or commonly used forms in order to pre-populate the form with information 280 associated with the user 205. The rendering system 200 further partially completes the forms 270 with respect to the user 205 based on the user information 380 stored in the database 260 associated with the server 250. Such an approach effectively provides on-demand rendering of forms 270 in an office environment.

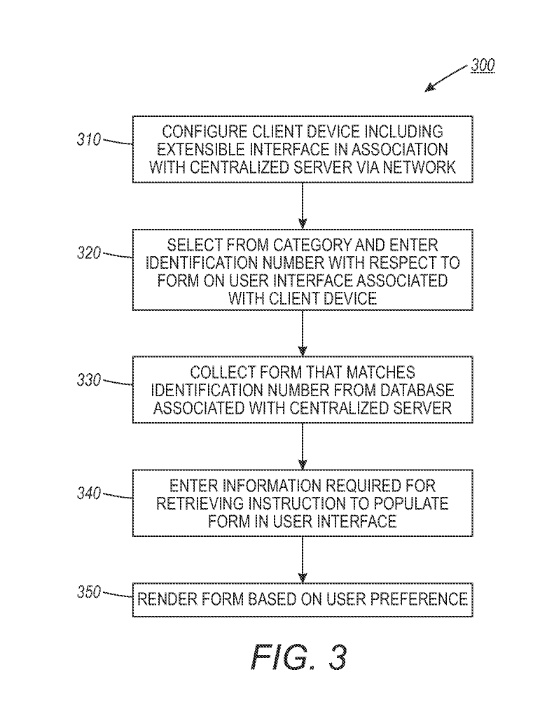

FIG. 3 illustrates a high level flow chart of operation illustrating logical operation steps of a method 300 for rendering a form 270 based on the identification number 240, in accordance with the disclosed embodiments. Note that the method 300 can be implemented in the context of a computer-useable medium that contains a program product, including, for example, a module or group of modules. The client device 210 including the EIP application 230 can be configured in association with the centralized server 210 via the network 135, as illustrated at block 310. The form category 235 and form identification number 240 with respect to the form 270 can be further provided to the centralized server 250 via the user interface 220, as depicted at block 320.

The list of forms that matches the form identification number 240 can be collected from the database 260 associated with the server 250, as indicated at block 230. The information required for retrieving instruction required to populate the form 270 can be entered in the user interface 220 associated with the client device 210, as illustrated at block 240. Thereafter, the form 270 can be rendered based on the user preferences, as indicated at block 350. Such an approach updates the forms without rendering and shipping to a delivery point.

Note that programs defining functions with respect to the disclosed embodiments may be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including, for example, Ethernet, the Internet, wireless networks, other networked systems. Thus, the method 300 described herein can be deployed as process software in the context of the client device as that depicted in FIG. 2.

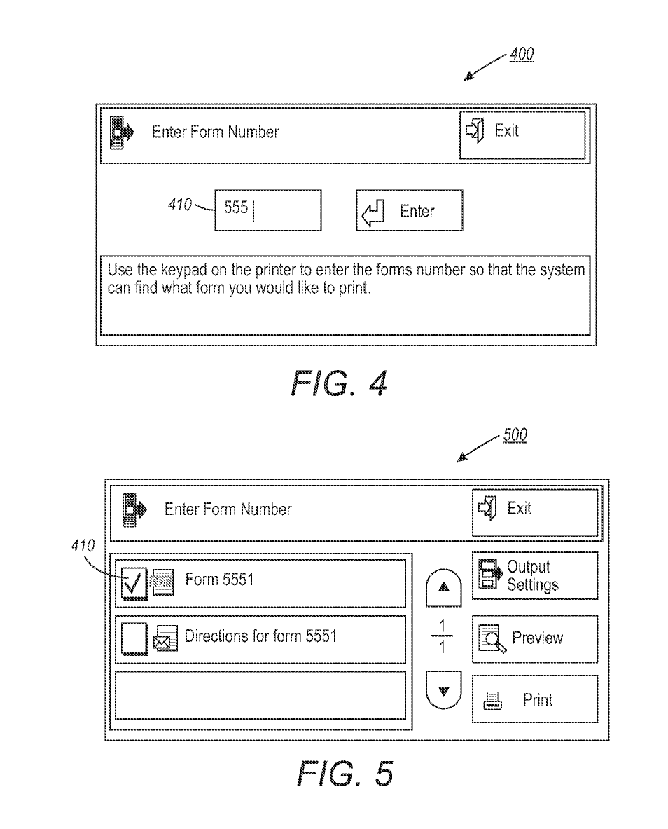

FIG. 4 illustrates a GUI 400 for entering the form identification number 240 associated with the form 270, in accordance with the disclosed embodiments. Note that the GUI 400 and/or 500 can be implemented utilizing a GUI such as, for example, the GUI 145 depicted in FIG. 1 herein. GUI 400 and/or 500 can be displayed via a display device such as monitor 115 depicted in FIG. 1. In the illustrated figures herein, 400 and/or 500 are generally implemented in the context of a GUI “window”. Note that in computing, a GUI window is generally a visual area containing some type of user interface (e.g., GUI 145). Such a “window” usually (but not always) possesses a rectangular shape, and displays the output of and may allow input to one or more processes. Such windows are primarily associated with graphical displays, where they can be manipulated with a mouse cursor, such as, for example, the pointing device 130 depicted in FIG. 1. A GUI using windows as one of its main “metaphors” is often referred to as a windowing system.

The user interface 400 displays the form 270 associated with the form identification number 240. The form identification number 240 with respect to the form 270 can be entered in a graphically displayed box 410. The user 205 may typically access a keypad associated with the client device 210 for providing the form identification number 240. The list of forms can be retrieved from the server 250 and displayed at the user interface 220 of the client device 210. The GUI 400 displays the form 270 associated with the form identification number 240, in accordance with the disclosed embodiments. Note that the form 270 can be a formatted electronic document which contains blank fields for filling appropriate data such as, for example, tax form, and mail form etc. The system and method can be therefore effectively employed in a wide variety of business applications for rendering forms such as invoices, credit and debit notes, checks, petty-cash slips, etc., that are relatively expensive on a per transaction basis.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method, comprising:
selecting a form category by accessing an extensible interface platform application associated with a client device in order to thereafter provide an identification number with respect to a form at a user interface associated with said client device; and
collecting said form that matches said identification number from a database associated with a centralized server in order to thereafter provide an information required for retrieving an instruction to populate said form in said user interface.

2. The method of claim 1 further comprising configuring said client device in association with said centralized server via a network.

3. The method of claim 1 further comprising rendering said form based on a user preference thereby reducing a cost of rendering and shipping said form to a plurality of locations.

4. The method of claim 1 further comprising prompting said user to enter said identification number associated with said form.

5. The method of claim 1 further comprising providing an authentication process to said user before selecting said form in order to pre-populate said form with information associated with said user.

6. The method of claim 1 further comprising presenting said user with a list of recently used forms upon authentication.

7. The method of claim 1 wherein said client device comprises a rendering device.

8. The method of claim 1 further comprising providing said information required for retrieving said instruction to populate said form via a card reader.

9. The method of claim 1 further comprising providing said information required for retrieving said instruction to populate said form via an integrated input device.

10. A system, comprising:
a processor;
a data bus coupled to said processor; and
a computer-usable medium embodying computer code, said computer-usable medium being coupled to said data bus, said computer program code comprising instructions executable by said processor and configured for:
selecting a form category by accessing an extensible interface platform application associated with a client device in order to thereafter provide an identification number with respect to a form at a user interface associated with said client device; and
collecting said form that matches said identification number from a database associated with a centralized server in order to thereafter provide an information required for retrieving an instruction to populate said form in said user interface.

11. The system of claim 10 wherein said instructions are further configured for associating said client device with said centralized server via a network.

12. The system of claim 10 wherein said instructions are further configured for rendering said form based on a user preference thereby reducing a cost of rendering and shipping said form to a plurality of locations.

13. The system of claim 10 wherein said instructions are further configured for prompting said user to enter said identification number associated with said form.

14. The system of claim 10 wherein said instructions are further configured for providing an authentication process to said user before selecting said form in order to pre-populate said form with information associated with said user.

15. The system of claim 10 wherein said instructions are further configured for presenting said user with a list of recently used forms upon authentication.

16. The system of claim 10 wherein said client device comprises a rendering device.

17. The system of claim 10 wherein said instructions are further configured for providing said information required for retrieving said instruction to populate said form via a card reader.

18. The system of claim 10 wherein said instructions are further configured for providing said information required for retrieving said instruction to populate said form via an integrated input device.

19. A system, comprising:
a processor;
a data bus coupled to said processor; and
a computer-usable medium embodying computer code, said computer-usable medium being coupled to said data bus, said computer program code comprising instructions executable by said processor and configured for:
selecting a form category by accessing an extensible interface platform application associated with a client device in order to thereafter provide an identification number with respect to a form at a user interface associated with said client device;
collecting said form that matches said identification number from a database associated with a centralized server in order to thereafter provide an information required for retrieving an instruction to populate said form in said user interface; and
associating said client device with said centralized server via a network.

20. The system of claim 19 wherein said instructions are further configured for rendering said form based on a user preference thereby reducing a cost of rendering and shipping said form to a plurality of locations.
